(19) United States
(12) Patent Application Publication
(10) Pub. No.: US 2021/0042395 A1
(43) Pub. Date: Feb. 11, 2021

(54) CONNECTOR WEAR CORRELATION AND PREDICTION ANALYSIS

(71) Applicant: International Business Machines Corporation, Armonk, NY (US)

(72) Inventors: Shawn Canfield, Poughkeepsie, NY (US); Suraush Khambati, Poughkeepsie, NY (US); Budy Notohardjono, Poughkeepsie, NY (US); Richard M. Ecker, Poughkeepsie, NY (US)

(21) Appl. No.: 16/535,116

(22) Filed: Aug. 8, 2019

(51) Int. Cl. G06F 17/50; H01R 13/00

(52) U.S. Cl. CPC G06F 17/5018; G06F 2217/16; G06F 2217/14; H01R 13/00

(57) ABSTRACT

In an approach to predicting connector wear over time, a computer retrieves a first global finite element model associated with an electronic assembly, wherein the electronic assembly includes at least one connector pair. The computer retrieves test data associated with at least one vibration test of the electronic assembly. The computer runs the first global finite element model with the retrieved test data. The computer determines connector displacement versus time data of the at least one connector pair. The computer retrieves a local finite element model associated with the at least one connector pair. The computer determines a wear coefficient associated with the at least one connector pair. The computer runs the local finite element model with the connector displacement versus time data and with the wear coefficient. The computer determines wear over time of at least one contact of the at least one connector pair.

### STATEMENT ON PRIOR DISCLOSURES BY AN INVENTOR

The following disclosure(s) are submitted under 35 U.S.C. 102(b)(1)(A) as prior disclosures by, or on behalf of, a sole inventor of the present application or a joint inventor of the present application:

“Mainframe Computer Connector Wear Correlation and Prediction Analysis”, by Shawn Canfield, Budy Notohardjono, Richard Ecker, Suraush Khambati, IBM Corporation, published May 15, 2019, at:

https://www.dynamore.de/en/downloads/papers/copy_of_european-ls-dyna-conference/agenda-2019 (9 page).

### BACKGROUND OF THE INVENTION

The present invention relates generally to the field of wear simulation modeling, and more particularly to connector wear correlation and prediction analysis.

Finite element modelling (FEM), is a numerical method for solving problems of engineering and mathematical physics. Typical problem areas of interest include structural analysis, heat transfer, fluid flow, mass transport, and electromagnetic potential. To solve the problem, FEM subdivides a large system into smaller, simpler parts that are called finite elements. The simple equations that model these finite elements are then assembled into a larger system of equations that models the entire problem. FEM then uses variational methods from the calculus of variations to approximate a solution by minimizing an associated error function. FEM allows detailed visualization of where structures bend or twist and indicates the distribution of stresses and displacements. FEM software provides a wide range of simulation options for controlling the complexity of both modeling and analysis of a system. Similarly, the desired level of accuracy required and associated computational time requirements can be managed simultaneously to address most engineering applications. FEM allows entire designs to be constructed, refined, and optimized before the design is manufactured. The mesh is an integral part of the model and it must be controlled carefully to give the best results. Generally, the higher the number of elements in a mesh, the more accurate the solution of the discretised problem. The introduction of FEM has substantially decreased the time to take products from concept to the production line. It is primarily through improved initial prototype designs using FEM that testing and development have been accelerated. Benefits of FEM include increased accuracy, enhanced design, and better insight into critical design parameters, virtual prototyping, fewer hardware prototypes, a faster and less expensive design cycle, increased productivity, and increased revenue.

Connectors are used in electronic assemblies to provide a path for a signal from one component to another. There is a plurality of types of connectors designed for various applications, however, typically a connector includes one or more contacts for making the connection. Generally, a connector contact is constructed of copper which is plated with various metals to prevent corrosion of the copper due to oxidation in the operating environment. For example, the copper may be plated with 1.25 microns of nickel that is, in turn, plated with 0.8 microns of gold. The gold and nickel plating can ensure long term reliability, however care must be taken to prevent the plated layers from wearing off during manufacturing, shipping, and operation of the electronic assembly.

### SUMMARY

Embodiments of the present invention disclose a method, a computer program product, and a system for predicting connector wear over time. The method may include one or more computer processors retrieving a first global finite element model associated with an electronic assembly, wherein the electronic assembly includes at least one connector pair. The one or more computer processors retrieve test data associated with at least one vibration test of the electronic assembly. The one or more computer processors run the first global finite element model with the retrieved test data. Based on a result of running the first global finite element model, the one or more computer processors determine connector displacement versus time data of the at least one connector pair. The one or more computer processors retrieve a local finite element model associated with the at least one connector pair. The one or more computer processors determine a wear coefficient associated with the at least one connector pair. The one or more computer processors run the local finite element model with the connector displacement versus time data and with the wear coefficient. Based on a result of running the local finite element model, the one or more computer processors, determine wear over time of at least one contact of the at least one connector pair.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a wear analysis program, on a server computer within the distributed data processing environment of FIG. 1, for analyzing connector wear, in accordance with an embodiment of the present invention;

FIG. 3 depicts a diagram of a global finite element model using non-linear springs to represent connector pairs, in accordance with an embodiment of the present invention; and

FIG. 4 depicts a block diagram of components of the server computer executing the wear analysis program within the distributed data processing environment of FIG. 1, in accordance with an embodiment of the present invention.

### DETAILED DESCRIPTION

From manufacturing to installation, electronic assemblies, such as computing devices from laptops to mainframes, are subjected to environmental conditions that can adversely affect the reliability of the assembly. Examples of these conditions include, but are not limited to, shipping vibration while en-route to a destination and operational vibration after being installed in a final destination. Shipping vibration can induce connector wear that affects the long-term reliability of the electronic assembly. If connections are not positively retained, then sliding micro-motion between the male and female parts of a connector pair can occur as a result of shipping vibration, causing wear. During the product development cycle, the ability to predict the performance of connectors under shipping vibration is critical in optimizing the design to prevent connector wear which can impact long term connection reliability. Vibration testing is often performed as part of a product development cycle, and subsequent analysis of connector contacts under a scanning electron microscope (SEM), or similar tool, can detect the thickness of remaining plated layers. However, inspection of the contacts after testing only gives an indication of the final outcome of the test and cannot quantify the accumulation of wear over time. A full finite element model (FEM) analysis of a system can be performed, however for a large computing system, a full FEM can comprise millions of elements and hundreds of thousands of nodes, requiring weeks to process.

Embodiments of the present invention recognize that improvements to traditional methods can be made by generating an accurate, simplified finite element model for analyzing and correlating connector motion and connector wear due to vibration that can be solved in significantly less time than a full FEM. Embodiments of the present invention provide a quantitative measure of connector wear, instead of simply a pass/fail post-test inspection with a microscope, which can drive design and assessment across different connector types. Embodiments of the present invention provide a computationally efficient technique to significantly reduce product development time and improve the accuracy of connector wear prediction. Embodiments of the present invention provide a method to quantitatively compute, store, and deploy wear coefficients for different materials and connectors to and from a database. Implementation of embodiments of the invention may take a variety of forms, and exemplary implementation details are discussed subsequently with reference to the Figures.

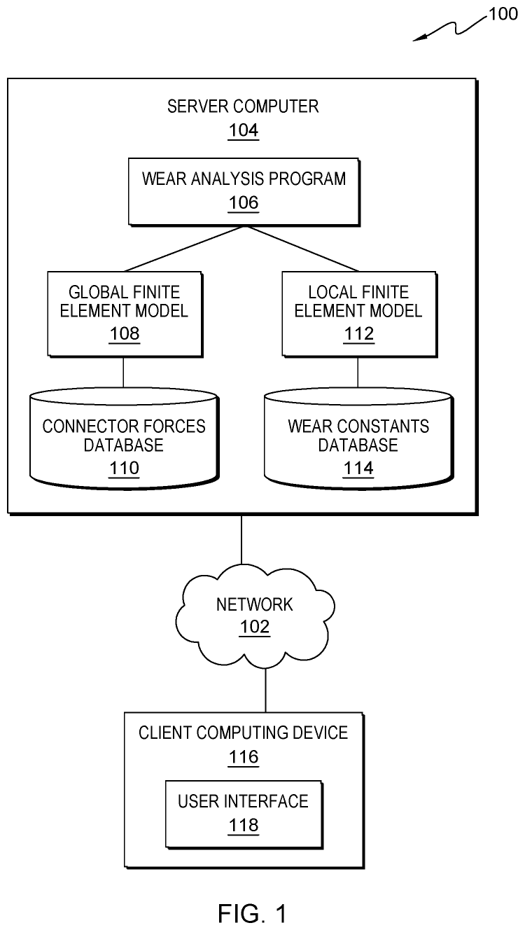

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 116, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104 and client computing device 116, and other computing devices (not shown) within distributed data processing environment 100.

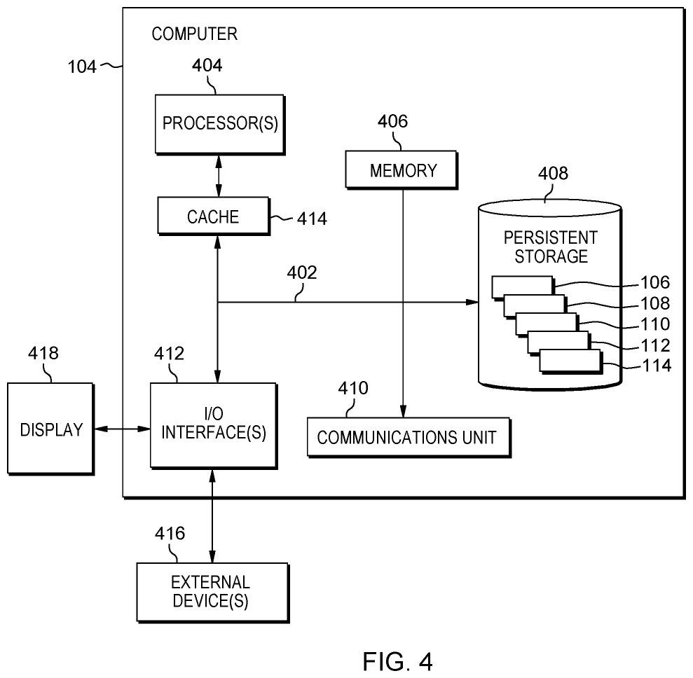

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with client computing device 116 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes wear analysis program 106, global finite element model (FEM) 108, connector forces database 110, local finite element model (FEM) 112, and wear constants database 114. Server computer 104 may include internal and external hardware components, as depicted and described in further detail with respect to FIG. 4.

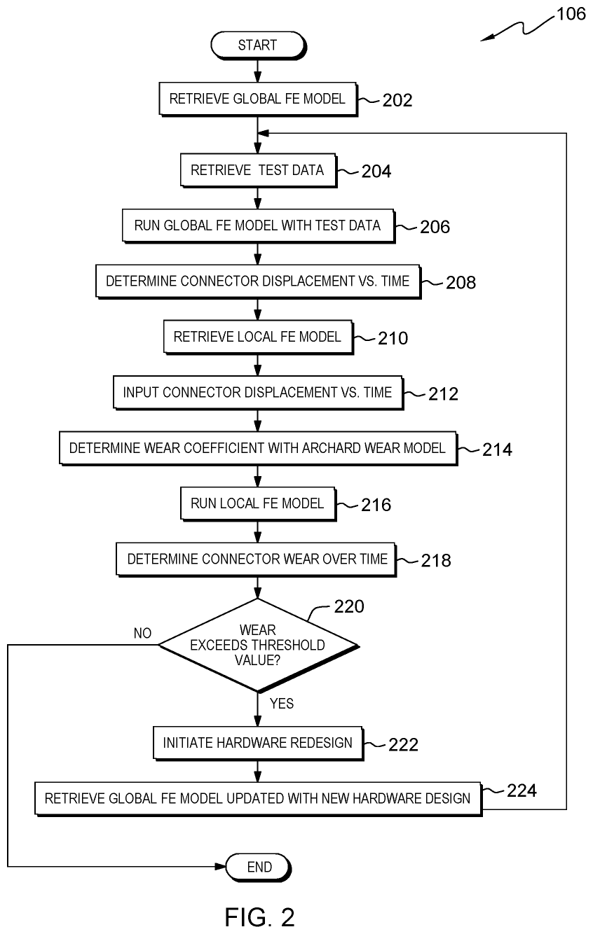

Wear analysis program 106 analyzes connector wear by modelling connector pairs in two different ways and deriving an equivalence between them. Wear analysis program 106 models connector contacts as non-linear springs in a global model, such as global FEM 108, and models frictional contact between connector pairs in a local model, such as local FEM 112, using the models in unison. Wear analysis program 106 retrieves global FEM 108 and retrieves test data. Wear analysis program 106 runs global FEM 108 with the test data in order to determine connector displacement versus time. Wear analysis program 106 retrieves local FEM 112 and inputs the connector displacement versus time data from global FEM 108. Wear analysis program 106 determines a wear coefficient using the Archard wear model. Wear analysis program 106 runs local FEM 112 and determines connector wear over time. If wear analysis program 106 determines the connector wear over time exceeds a threshold value, then wear analysis program 106 initiates a hardware redesign and retrieves global FEM 108 updated with the new hardware design. Wear analysis program 106 is depicted and described in further detail with respect to FIG. 2.

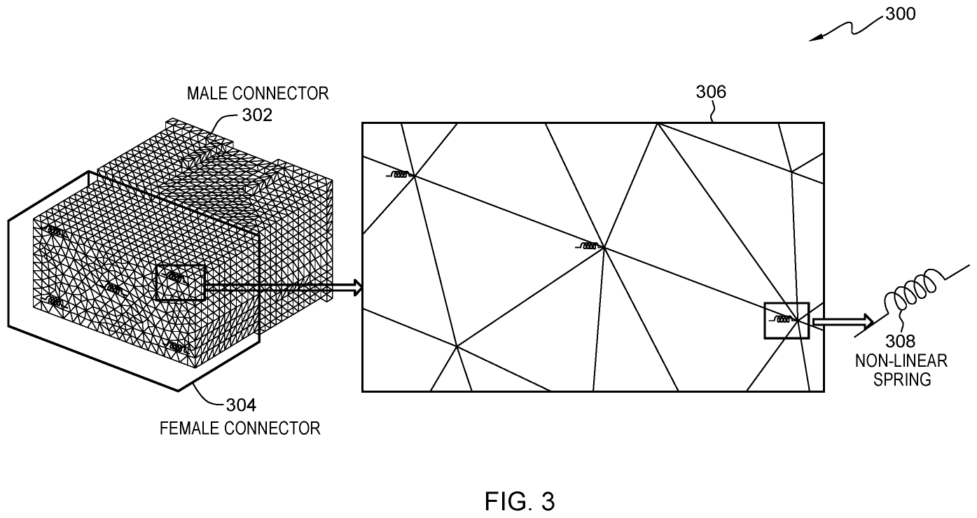

Global FEM 108 is a large finite element model of the structure of a full electronic assembly where the geometry of each connector in the assembly is simplified with its mating surfaces idealized to provide frictional force due to plugging/unplugging, or sliding against each other, during vibration. In global FEM 108, non-linear springs represent the connector interfaces to simulate the stick-slip frictional force of plugging/unplugging recorded in an actual vibration test. Global FEM 108 outputs relative motion between connector interfaces in three directions, i.e., displacement versus time. Global FEM 108 is depicted and described in further detail with respect to FIG. 3.

Connector forces database 110 is a repository for data used by wear analysis program 106. In the depicted embodiment, connector forces database 110 resides on server computer 104. In another embodiment, connector forces database 110 may reside on client computing device 116 or elsewhere within distributed data processing environment 100 provided wear analysis program 106 has access to connector forces database 110. A database is an organized collection of data. Connector forces database 110 can be implemented with any type of storage device capable of storing data and configuration files that can be accessed and utilized by wear analysis program 106, such as a database server, a hard disk drive, or a flash memory. Connector forces database 110 stores data used by wear analysis program 106 to run global FEM 108, such as stick-slip frictional forces measured as a result of a vertically applied random vibration to actual plugged connectors. In one embodiment, connector forces database 110 includes data resulting from mechanical testing. In another embodiment, connector forces database 110 may also include data supplied by the connector manufacturer.

Local FEM 112 is a finite element model of a detailed connector pair that includes an order of magnitude less elements and nodes than global FEM 108; thus, it runs relatively quickly as compared to global FEM 108. Local FEM 112 estimates the volumetric wear that occurs over time at the connector contacts using the same random vibration input used for global FEM 108. The ability to estimate wear over time is useful for future design improvements and reduces destructive hardware testing. Local FEM 112 uses a coefficient of friction applicable to the connector contacts, for example, gold-on-gold, coupled with a normal force to approximate a nominal unplug force specified for the specific connector assembly. Wear analysis program 106 calculates a wear coefficient using the Archard wear model. Wear analysis program 106 couples local FEM 112 with the Archard wear model to determine volumetric connector wear over time.

Wear constants database 114 is a repository for data used by wear analysis program 106. In the depicted embodiment, wear constants database 114 resides on server computer 104. In another embodiment, wear constants database 114 may reside on client computing device 116 or elsewhere within distributed data processing environment 100 provided wear analysis program 106 has access to wear constants database 114. Wear constants database 114 can be implemented with any type of storage device capable of storing data and configuration files that can be accessed and utilized by wear analysis program 106, such as a database server, a hard disk drive, or a flash memory. Wear constants database 114 stores data used by wear analysis program 106 to run local FEM 112, such as various constants and data to calculate constants used in the Archard wear model, as will be discussed with respect to FIG. 2.

Client computing device 116 can be a laptop computer, a tablet computer, a smart phone, smart watch, a smart speaker, or any programmable electronic device capable of communicating with various components and devices within distributed data processing environment 100, via network 102. Client computing device 116 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In general, client computing device 116 represents one or more programmable electronic devices or combination of programmable electronic devices capable of executing machine readable program instructions and communicating with other computing devices (not shown) within distributed data processing environment 100 via a network, such as network 102. In one embodiment, client computing device 116 represents one or more devices associated with a user. Client computing device 116 includes an instance of user interface 118.

User interface 118 enables a user to make requests of or issue commands to client computing device 116 and receive information and instructions in response. In one embodiment, user interface 118 is a voice user interface (VUI) for a user of client computing device 116 to access via voice commands in natural language. In one embodiment, user interface 118 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 118 may also be mobile application software. In an example, mobile application software, or an “app,” is a computer program designed to run on smart phones, tablet computers and other mobile devices. User interface 118 enables a user of client computing device 116 to interact with wear analysis program 106.

FIG. 2 is a flowchart depicting operational steps of wear analysis program 106, on server computer 104 within distributed data processing environment 100 of FIG. 1, for analyzing connector wear, in accordance with an embodiment of the present invention.

Wear analysis program 106 retrieves global FEM 108 (step 202). As would be appreciated by a person of skill in the art, a user sets up global FEM 108 to represent an electronic assembly. In one embodiment, the user sets up various components of the electronic assembly, mid-surfaced and meshed as 4-node quadrilateral elements, and soldered components offset and bonded with spacer bodies. In the embodiment, the user also assigns individual component material models, both linear and non-linear. In global FEM 108, non-linear springs represent the connector interfaces to simulate the stick-slip frictional force of plugging/unplugging recorded in an actual vibration test. In one embodiment, the user assigns a load curve to the non-linear springs based on data retrieved from connector forces database 110. In the depicted embodiment, the user stores global FEM 108 on server computer 104. In another embodiment, the user may store global FEM 108 elsewhere in distributed data processing environment 100 provided that wear analysis program 106 can access global FEM 108. Wear analysis program 106 retrieves global FEM 108 and readies global FEM 108 to be run.

Wear analysis program 106 retrieves test data (step 204). Wear analysis program 106 retrieves test data stored in connector forces database 110. In one embodiment, wear analysis program 106 retrieves results from random vibration testing run to simulate shipping vibration that may be experienced by the electronic assembly. In one embodiment, the electronic assembly was subjected to vertical random vibration test condition equivalent to 0.8 root mean square acceleration (Grms) for fifteen minutes. The resulting test data represents the response of various monitored component designs, such as a connector design, to a standard shipping random vibration profile. The retrieved test data may include, but is not limited to, stick-slip frictional forces measured as a result of a vertically applied random vibration to actual plugged connectors.

Wear analysis program 106 runs global FEM 108 with retrieved test data (step 206). Wear analysis program 106 inputs a portion of the retrieved random vibration test data to global FEM 108 and runs global FEM 108. For example, wear analysis program 106 may input a two second sample of a fifteen-minute random vibration test at 0.8 Grms that represents the highest magnitude experienced in the test.

Wear analysis program 106 determines connector displacement versus time (step 208). As a result of running global FEM 108 with the retrieved test data, wear analysis program 106 determines connector displacement versus time, i.e., relative motion between the two sides of a connector contact in three axes. In one embodiment, wear analysis program 106 stores the connector displacement versus time data in wear constants database 114. In one embodiment, wear analysis program 106 determines whether detailed mechanical test data is available for comparison to the results of running global FEM 108. If detailed mechanical test data is available, then wear analysis program 106 determines whether accelerometer and capacitive displacement data from the mechanical testing match the results of running global FEM 108. If accelerometer and capacitive displacement data from the mechanical testing match the results of running global FEM 108, then wear analysis program 106 validates global FEM 108 as being consistent with the test data. If accelerometer and capacitive displacement data from the mechanical testing do not match the results of running global FEM 108, then wear analysis program 106 updates boundary conditions associated with global FEM 108 and re-runs global FEM 108 iteratively until a match is achieved.

Wear analysis program 106 retrieves local FEM 112 (step 210). As would be appreciated by a person of skill in the art, a user sets up local FEM 112 to represent a detailed connector pair, i.e., the mating contacts of two connectors. By constructing a local model, the user avoids adding more detail to global FEM 108, which may significantly increase the solve time. In the depicted embodiment, the user stores local FEM 112 on server computer 104. In another embodiment, the user may store local FEM 112 elsewhere in distributed data processing environment 100 provided that wear analysis program 106 can access local FEM 112. Wear analysis program 106 retrieves local FEM 112 and readies local FEM 112 to be run.

Wear analysis program 106 inputs connector displacement versus time into local FEM 112 (step 212). Wear analysis program 106 inputs the connector contact displacement versus time data produced by global FEM 108 into local FEM 112, thus deriving an equivalence between the two models by using them in unison.

Wear analysis program 106 determines wear coefficient with Archard wear model (step 214). The Archard wear model, as would be recognized by a person of skill in the art, relates the rate of material volume loss to contact interface pressure and the relative sliding velocity at the wear interface. The Archard wear model determines the rate of material volume loss as follows:

$$w = \frac{{K}_{time} {K}_{wear}}{H} P {v}_{r e l}$$

where w is the rate of material loss, Kₜᵢₘₑ is a time scale factor, K_{wear} is the wear coefficient, P is contact interface pressure, vᵣₑₗ is the relative sliding velocity, and H is material hardness. Use of Kₜᵢₘₑ enables a computationally efficient, yet accurate evaluation. In an embodiment, Kₜᵢₘₑ is a ratio between a test time and an analysis time. For example, Kₜᵢₘₑ may be a ratio of fifteen minutes of test time versus an analysis time of two seconds. The contact interface pressure, P, is a constant that can either be estimated, via modelling, or measured, via testing. The relative sliding velocity, vᵣₑₗ, is equivalent to connector contact displacement versus time, which is the result of running global FEM 108. Material hardness, H, is a constant for each material. For example, the material hardness of copper is 120 HV. The rate of material loss, w, can initially be measured by inspecting a connector contact after vibration testing under known relative motion conditions and measuring the amount of gold and nickel missing from the surface of the contact. For example, the inspection may be performed with a scanning electron microscope (SEM). In an embodiment, the above-named constants are stored in wear constants database 114. Wear analysis program 106 solves the Archard wear model equation for K_{wear} using the constants. In an embodiment, wear analysis program 106 stores K_{wear} in wear constants database 114.

Wear analysis program 106 runs local FEM 112 (step 216). Wear analysis program 106 runs local FEM 112 using the inputs derived from the results of running global FEM 108 and from determining the wear coefficient using the Archard wear model. Local FEM 112 runs relatively quickly, as compared to global FEM 108, and therefore is a more efficient method for determining connector wear over time.

Wear analysis program 106 determines connector wear over time (step 218). The results of running local FEM 112 are an estimate of an amount of volumetric connector wear over time for a particular contact pair. In one embodiment, wear analysis program 106 determines whether detailed mechanical test data is available for comparison to the results of running local FEM 112. If detailed mechanical test data is available, then wear analysis program 106 determines whether SEM results from inspecting a contact pair after the mechanical testing match the connector wear profile and depth estimated by running local FEM 112. If the SEM results from the mechanical testing match the results of running local FEM 112, then wear analysis program 106 updates wear constants database 114 by storing K_{wear}. If the SEM results from the mechanical testing do not match the results of running local FEM 112, then wear analysis program 106 adjusts K_{wear} and re-runs local FEM 112 iteratively until a match is achieved.

Wear analysis program 106 determines whether the connector wear over time exceeds a threshold value (decision block 220). In one embodiment, the threshold value is a depth of missing plating accumulated over time. For example, if a connector contact is plated with 0.8 microns of gold over 1.25 microns of nickel, then the threshold value is 0.8 microns, i.e., the depth at which the nickel layer is exposed, over the time exposed to vibration, for example, two seconds. In another embodiment, the threshold may be a volume of material removed from the contact over time, which takes into account the size of the wear mark. In a further embodiment, the threshold may be an area of the wear mark over time.

If wear analysis program 106 determines the connector wear over time exceeds a threshold value (“yes” branch, decision block 220), then wear analysis program 106 initiates hardware redesign (step 222). If the connector wear over time exceeds the threshold value, then the amount of wear on the contact pair is unacceptable for long term reliability. Wear analysis program 106 initiates a hardware redesign to bring the estimated total wear to a value less than the threshold. In one embodiment, wear analysis program 106 alerts the user, via user interface 118, that the wear over time exceeds the threshold and a redesign is required. In one embodiment, wear analysis program 106 alerts the user by sending an email. In another embodiment, wear analysis program 106 may send the user a text message. In a further embodiment, wear analysis program 106 may flash the alert on a screen associated with client computing device 116. In one embodiment, the alert states “redesign required.” In another embodiment, the alert includes a detailed report of the results of running local FEM 112.

Wear analysis program 106 retrieves global FEM 108 updated with new hardware design (step 224). The hardware is redesigned to reduce the motion between connector contact pairs to reduce wear over time. Following the hardware redesign, the user sets up global FEM 108 to represent the electronic assembly that includes the modifications to the design. For example, components can be removed from the electronic assembly to reduce the weight of the electronic assembly, in order to reduce motion of the electronic assembly during vibration. In another example, an elastomer block may be added to the electronic assembly to preload the connector to hold the connector firmly and limit motion. Once the user sets up an updated version of global FEM 108, wear analysis program 106 retrieves the updated version and returns to step 204 to work iteratively through steps 204 to 220 until a design is found that minimizes wear over time such that the wear threshold is not exceeded.

If wear analysis program 106 determines the wear over time does not exceed a threshold value (“no” branch, decision block 220), then wear analysis program 106 ends. If the calculated wear does not exceed the threshold value, then the design is considered robust, achieving a durability standard.

FIG. 3 depicts diagram 300 of global FEM 108 using non-linear springs to represent connector pairs, in accordance with an embodiment of the present invention.

Diagram 300 includes a finite element model depiction of male connector 302 connected to female connector 304, shown as a connector pair. Box 306 is an enlargement of an area between male connector 302 and female connector 304 where nodes of the two halves of the pair meet. Non-linear spring 308 represents a non-linear spring that connects nodal pairs. The user identifies connector pair edges between male connector 302 and female connector 304, for example, one edge per corner and one in the center, for a total of ten edges, to ensure uniform distribution across the connector face. The user can then export nodal information of the ten edges to a numerical computing environment tool, as would be recognized by one skilled in the art. The tool finds the edge pairs within a user specified search distance, for example, 0.25 mm, and breaks each edge in half. As each edge has a beginning and an end point, splitting the edge in half creates a midpoint, for a total of 3 points, i.e., nodes, per edge. Nodal pairs for each of the edges are connected with non-linear springs, such as non-linear spring 308. The user assigns a defined load curve, i.e., force versus displacement, to the non-linear spring that represents plugging/unplugging forces known for the connector pair. Thus, by using a non-linear spring in global FEM 108, the stick-slip frictional force of plugging/unplugging is accounted for. In one embodiment, the non-linear spring force deflection curve is defined to resist motion in either direction until an axial force equal to a threshold value is reached, after which the non-linear spring curve provides no additional resistance, allowing for a stick-slip condition approximating actual frictional forces experienced in a connector system when fully plugged.

FIG. 4 depicts a block diagram of components of server computer 104 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 104 can include processor(s) 404, cache 414, memory 406, persistent storage 408, communications unit 610, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., wear analysis program 106, global FEM 108, connector forces database 110, local FEM 112, and wear constants database 114, are stored in persistent storage 408 for execution and/or access by one or more of the respective processor(s) 404 of server computer 104 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing device 116. In these examples, communications unit 410 includes one or more network interface cards. Communications unit 410 may provide communications through the use of either or both physical and wireless communications links. Wear analysis program 106, global FEM 108, connector forces database 110, local FEM 112, wear constants database 114, and other programs and data used for implementation of the present invention, may be downloaded to persistent storage 408 of server computer 104 through communications unit 410.

I/O interface(s) 412 allows for input and output of data with other devices that may be connected to server computer 104. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention, e.g., wear analysis program 106, global FEM 108, connector forces database 110, local FEM 112, and wear constants database 114, can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor. Display 418 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for predicting connector wear over time, the method comprising:
retrieving, by one or more computer processors, a first global finite element model associated with an electronic assembly, wherein the electronic assembly includes at least one connector pair;
retrieving, by the one or more computer processors, test data associated with at least one vibration test of the electronic assembly;
running, by the one or more computer processors, the first global finite element model with the retrieved test data;
based on a result of running the first global finite element model, determining, by the one or more computer processors, connector displacement versus time data of the at least one connector pair;
retrieving, by the one or more computer processors, a local finite element model associated with the at least one connector pair;
determining, by the one or more computer processors, a wear coefficient associated with the at least one connector pair;
running, by the one or more computer processors, the local finite element model with the connector displacement versus time data and with the wear coefficient; and
based on a result of running the local finite element model, determining, by the one or more computer processors, wear over time of at least one contact of the at least one connector pair.

2. The method of claim 1, further comprising:
determining, by the one or more computer processors, the determined wear over time of the at least one contact exceeds a threshold value; and
initiating, by the one or more computer processors, a redesign of the electronic assembly.

3. The method of claim 2, further comprising, retrieving, by the one or more computer processors, a second global finite element model, wherein the second global finite element model is associated with the redesign of the electronic assembly.

4. The method of claim 2, wherein the threshold value of wear over time of the at least one contact is selected from the group consisting of: a depth of missing plating of the at least one contact over time, a volume of material removed from the at least one contact over time, and an area of a wear mark on the at least one contact over time.

5. The method of claim 1, wherein determining the wear coefficient associated with the at least one connector pair comprises utilizing, by the one or more computer processors, an Archard wear model.

6. The method of claim 1, wherein the first global finite element model includes one or more non-linear springs representing mating surfaces of the at least one connector pair.

7. The method of claim 6, wherein a force deflection curve associated with the one or more non-linear springs is defined to approximate one or more frictional forces experienced in a connector system during plugging and unplugging.

8. A computer program product for predicting connector wear over time, the computer program product comprising:
one or more computer readable storage devices and program instructions stored on the one or more computer readable storage devices, the stored program instructions comprising:
program instructions to retrieve a first global finite element model associated with an electronic assembly, wherein the electronic assembly includes at least one connector pair;
program instructions to retrieve test data associated with at least one vibration test of the electronic assembly;
program instructions to run the first global finite element model with the retrieved test data;
based on a result of running the first global finite element model, program instructions to determine connector displacement versus time data of the at least one connector pair;
program instructions to retrieve a local finite element model associated with the at least one connector pair;
program instructions to determine a wear coefficient associated with the at least one connector pair;
program instructions to run the local finite element model with the connector displacement versus time data and with the wear coefficient; and
based on a result of running the local finite element model, program instructions to determine wear over time of at least one contact of the at least one connector pair.

9. The computer program product of claim 8, the stored program instructions further comprising:
program instructions to determine the determined wear over time of the at least one contact exceeds a threshold value; and
program instructions to initiate a redesign of the electronic assembly.

10. The computer program product of claim 9, the stored program instructions further comprising, program instructions to retrieve a second global finite element model, wherein the second global finite element model is associated with the redesign of the electronic assembly.

11. The computer program product of claim 9, wherein the threshold value of wear over time of the at least one contact is selected from the group consisting of: a depth of missing plating of the at least one contact over time, a volume of material removed from the at least one contact over time, and an area of a wear mark on the at least one contact over time.

12. The computer program product of claim 8, wherein the program instructions to determine the wear coefficient associated with the at least one connector pair comprise program instructions to utilize an Archard wear model.

13. The computer program product of claim 8, wherein the first global finite element model includes one or more non-linear springs representing mating surfaces of the at least one connector pair.

14. The computer program product of claim 13, wherein a force deflection curve associated with the one or more non-linear springs is defined to approximate one or more frictional forces experienced in a connector system during plugging and unplugging.

15. A computer system for predicting connector wear over time, the computer system comprising:
one or more computer processors;
one or more computer readable storage devices;
program instructions stored on the one or more computer readable storage devices for execution by at least one of the one or more computer processors, the stored program instructions comprising:
program instructions to retrieve a first global finite element model associated with an electronic assembly, wherein the electronic assembly includes at least one connector pair;
program instructions to retrieve test data associated with at least one vibration test of the electronic assembly;
program instructions to run the first global finite element model with the retrieved test data;
based on a result of running the first global finite element model, program instructions to determine connector displacement versus time data of the at least one connector pair;
program instructions to retrieve a local finite element model associated with the at least one connector pair;
program instructions to determine a wear coefficient associated with the at least one connector pair;
program instructions to run the local finite element model with the connector displacement versus time data and with the wear coefficient; and
based on a result of running the local finite element model, program instructions to determine wear over time of at least one contact of the at least one connector pair.

16. The computer system of claim 15, the stored program instructions further comprising:
program instructions to determine the determined wear over time of the at least one contact exceeds a threshold value; and
program instructions to initiate a redesign of the electronic assembly.

17. The computer system of claim 16, the stored program instructions further comprising, program instructions to retrieve a second global finite element model, wherein the second global finite element model is associated with the redesign of the electronic assembly.

18. The computer system of claim 16, wherein the threshold value of wear over time of the at least one contact is selected from the group consisting of: a depth of missing plating of the at least one contact over time, a volume of material removed from the at least one contact over time, and an area of a wear mark on the at least one contact over time.

19. The computer system of claim 15, wherein the first global finite element model includes one or more non-linear springs representing mating surfaces of the at least one connector pair.

20. The computer system of claim 19, wherein a force deflection curve associated with the one or more non-linear springs is defined to approximate one or more frictional forces experienced in a connector system during plugging and unplugging.
